(19) United States
(12) Patent Application Publication
(10) Pub. No.: US 2005/0107036 A1
(43) Pub. Date: May 19, 2005

(54) Apparatus and method for transmitting and receiving commmon control information in a wireless communication system

(75) Inventors: Bong-Gee Song, Seongnam-si (KR); Yun-Sang Park, Suwon-si (KR); Kwang-Seop Eom, Seongnam-si (KR); Seung-Eun Hong, Suwon-si (KR); Min-Hee Cho, Suwon-si (KR); Hyeong-Jong Ju, Seoul (KR); Jae-Hee Cho, Seoul (KR)

Correspondence Address: DILWORTH & BARRESE, LLP, 333 EARLE OVINGTON BLVD., UNIONDALE, NY, 11553, US

(73) Assignee: SAMSUNG ELECRONICS CO., LTD, Gyeonggi-do (KR)

(21) Appl. No.: 10/993,192

(22) Filed: Nov. 19, 2004

(30) Foreign Application Priority Data
Nov. 19, 2003 (KR) 2003-82234
Mar. 5, 2004 (KR) 2004-15212

(51) Int. Cl. H04Q 7/20

(52) U.S. Cl. 455/23

(57) ABSTRACT

A method for transmitting common control information from a base station to a plurality of subscriber stations in a wireless communication. The common control information includes first information transmitted in common to all of the subscriber stations and second information separately transmitted to the subscriber stations according to channel states of the subscriber stations. The first information is transmitted using an MCS (Modulation and Coding Scheme) level having a modulation scheme with a lowest order and a coding scheme with a lowest coding rate among all MCS levels available in the base station. The second information is transmitted using MCS levels that are adjusted by a predetermined level against MCS levels corresponding to channel states of the subscriber stations.

### PRIORITY

This application claims priority under 35 U.S.C. § 119 to an application entitled “Apparatus and Method for Transmitting and Receiving Common Control Information in a Wireless Communication System” filed in the Korean Intellectual Property Office on Nov. 19, 2003 and assigned Serial No. 2003-82234, and an application entitled “Apparatus and Method for Transmitting and Receiving Common Control Information in a Wireless Communication System” filed in the Korean Intellectual Property Office on Mar. 5, 2004 and assigned Serial No. 2004-15212, the contents of both of which are incorporated herein by reference.

### BACKGROUND OF THE INVENTION

1. Field of the Invention

The present invention relates generally to a wireless communication system, and in particular, to an apparatus and method for transmitting and receiving common control information applied in common to subscriber stations.

2. Description of the Related Art

In a 4^{th} generation (4G) communication system, which is a next generation communication system, active research is being conducted on technology for providing users with services guaranteeing various Qualities-of-Service (QoSs) at a high data rate. A current 3^{rd} generation (3G) communication system generally supports a data rate of about 384 Kbps in an outdoor channel environment having a relatively poor channel environment, and supports a data rate of a maximum of 2 Mbps in an indoor channel environment having a relatively good channel environment.

Additionally, a Wireless Local Area Network (LAN) communication system and a Wireless Metropolitan Area Network (MAN) communication system generally support a data rate of 20 to 50 Mbps. Therefore, in the current 4G communication system, active research is being carried out on a new communication system securing mobility and QoS for the Wireless LAN communication system and the Wireless MAN communication system supporting a relatively high data rate in order to support a high-speed service.

The Wireless MAN communication system, more specifically, a Broadband Wireless Access (BWA) communication system, has wider coverage and supports a higher data rate, compared with the Wireless LAN communication system. An Institute of Electrical and Electronics Engineers (IEEE) 802.16a communication system utilizes Orthogonal Frequency Division Multiplexing (OFDM) scheme and/or Orthogonal Frequency Division Multiple Access (OFDMA) scheme to support a broadband transmission network for a physical channel of the Wireless MAN communication system. The IEEE 802.16a communication system is a BWA communication system using OFDM/OFDMA scheme.

FIG. 1 is a diagram schematically illustrating a conventional IEEE 802.16a communication system. Referring to FIG. 1, the IEEE 802.16a communication system has a single-cell configuration, and includes a base station (BS) 100 and a plurality of subscriber stations (SSs), i.e., a first subscriber station (SS#1) 110, a second subscriber station (SS#2) 120, a third subscriber station (SS#3) 130, a fourth subscriber station (SS#4) 140, and a fifth subscriber station (SS#5) 150, which are controlled by the base station 100. Signal exchange between the base station 100 and the subscriber stations 110, 120, 130, 140, and 150 is performed using OFDM/OFDMA scheme.

As illustrated in FIG. 1, the subscriber stations 110, 120, 130, 140, and 150 are different distances from the base station 100, and generally, radio wave environments, i.e., channel states, of the subscriber stations 110, 120, 130, 140, and 150 are different according to the distances from the base station 100. That is, the first subscriber station 110, which is the shortest distance from the base station 100, has the best channel state, and the fifth subscriber station 150, which has the longest distance from the base station 100, has the worst channel state.

In FIG. 1, the channel states will be distinguished into 5 states: ‘best’ state, ‘good’ state, ‘normal’ state, ‘bad’ state, and ‘worst’ state. Here, a criterion for distinguishing the 5 channel states is based on a threshold for distinguishing channel states provided in the IEEE 802.16a communication system. However, an operation of distinguishing channel states according to the threshold is not directly related to the present invention. Therefore, a detailed description thereof will be omitted herein.

In addition, although the channel states between the base station 100 and the subscriber stations 110, 120, 130, 140, and 150 are affected by the distances therebetween, and also by the obstacles existing between the base station 100 and the subscriber stations 110, 120, 130, 140 and 150, or interferences caused by other signals, it is assumed in FIG. 1 that the channel states are affected by the distances from the base station 100.

The current wireless communication system uses a burst characteristic of packet data in allocating radio resources for transmission of the packet data. In the following description, the wireless communication system refers to the IEEE 802.16a communication system.

Generally, in transmitting circuit data, the IEEE 802.16a communication system allocates a dedicated channel to a target subscriber station of the circuit data, and transmits the circuit data over the allocated dedicated channel. That is, for transmission of circuit data, the IEEE 802.16a communication system allocates a dedicated radio resource to a subscriber station, and transmits the circuit data over the allocated dedicated radio resource.

However, in transmitting packet data, the IEEE 802.16a communication system allocates a shared resource, i.e., a shared channel, rather than allocating the dedicated resource considering efficiency of radio resources, and transmits the packet data over the allocated shared channel. Therefore, a base station dynamically allocates downlink and uplink resources for each of its subscriber stations using a scheduling operation, and provides information on the allocated downlink and uplink resources to each of the subscriber stations in the form of common control information (CCI) every frame.

In addition, the IEEE 802.16a communication system modulates and codes a signal to be transmitted to a particular subscriber station using modulation and coding scheme appropriate for a radio ware environment, i.e., a channel state, of the subscriber station.

As described above, the channel states of a base station and subscriber stations are affected by various factors. Therefore, an Adaptive Modulation and Coding (AMC) scheme has been proposed as a scheme for transmitting a signal using different modulation and coding scheme according to the channel states between the base station and the subscriber stations. That is, the AMC scheme is a signal transmission scheme for selecting different modulation schemes and coding schemes according to channel states between a cell, or a base station, and subscriber stations, thereby improving efficiency of an entire cell.

The AMC scheme has a plurality of modulation schemes and a plurality of coding schemes, and modulates/codes a channel signal with a combination of the modulation schemes and coding schemes. Commonly, each of the combinations of the modulation schemes and coding schemes is called “MCSs,” and it is possible to define a plurality of MCSs of level 1 to level N according to the number of MCSs. More specifically, the AMC scheme is a scheme for adaptively selecting an MCS level according to the channel states between the base station and the suscriber stations, thereby improving efficiency of the entire base station system.

As described above, the IEEE 802.16a communication system controls signal exchange between a base station and subscriber stations according to a channel state of each of the subscriber stations using the AMC scheme. However, because common control information such as system information (SI) and resource allocation information should be received in common by all subscriber stations serviced by the base station, the base station must transmit the common control information with the most robust MCS level so that even the subscriber station having the worst channel state can normally receive the common control information.

For example, MCS levels provided in the IEEE 802.16a communication system are shown in table 1.

TABLE 1

| | | Resource Efficiency |
|---|---|---|
| MCS level index | Robust | (Info bits/Tx bits) |
| 0 | Very Robust | Lowest |
| 1 | Robust | Low |
| 2 | Normal | Normal |
| 3 | Weak | High |
| 4 | Very Weak | Highest |

As shown in Table 1, the IEEE 802.16a communication system provides 5 MCS levels , level 0 to level 4, and as an index of the MCS level increases, a channel state becomes better. In contrast, as an index of the MCS level decreases, a channel state becomes worse. That is, for MCS level=0, a modulation scheme having the lowest modulation order and a coding scheme having the lowest coding rate are used, thereby minimizing resource efficiency. However, for MCS level=4, a modulation scheme having the highest modulation order and a coding scheme having the highest coding rate are used, thereby maximizing resource efficiency.

In addition, MCS parameters corresponding to the MCS levels are included in a Downlink Channel Descriptor (DCD) message in the case of a downlink, and included in an Uplink Channel Descriptor (UCD) message in the case of an uplink. The IEEE 802.16a communication system uses the MCS level index as a Downlink Interval Usage Code (DIUC) and an Uplink Interval Usage Code (UIUC) for the uplink and downlink. In addition, when the channel state is bad, it is necessary to insert additional bits to increase a signal reception rate.

An increase in number of the additionally inserted bits increases the reception rate but decreases resource efficiency (=number of information bits/number of transmission bits). In the IEEE 802.16a communication system, in order to guarantee a predetermined reception rate, the number of bits that should be additionally inserted according to a channel state is previously determined.

Referring to FIG. 1, because the first subscriber station 110 has the best channel state, although the base station 100 may select any one of the 5 MCS levels in transmitting a signal, the first subscriber station 110 can receive the signal without error. However, the base station 100 selects the MCS level 4 among the 5 MCS levels in transmitting a signal to the first subscriber station 110, taking resource efficiency into consideration. However, because the fifth subscriber station 150 has the worst channel state, the base station 100 should select the MCS level 0, which is the most robust MCS level in transmitting a signal to the fifth subscriber station 150, such that the fifth subscriber station 150 can normally receive the signal.

In order to perform communication between a base station and a subscriber station, the base station and the subscriber station should exchange signals using the same MCS level. If an MCS level used in the base station is different from an MCS level used in the subscriber station, normal signal exchange between the base station and the subscriber station cannot be achieved. A process of exchanging information on a determined MCS level between the base station and the subscriber station is not directly related to the present invention, therefore, a detailed description thereof will be omitted herein.

As described above, because the common control information should be received in common by all subscriber stations of the first subscriber station 110 to the fifth subscriber station 150 serviced by the base station 100, the base station 100 should transmit the common control information with the MCS level 0, which is the most robust MCS level, so that even the subscriber station having the worst channel state, i.e., the fifth subscriber station 150, among the first to fifth subscriber stations 110 to 150 can normally receive the common control information.

Before a description of the common control information is given, it will be assumed herein that a downlink MAP (DL_MAP) message and an uplink MAP (UL_MAP) message of the IEEE 802.16a communication system are examples of the common control information. Information elements (IEs) included in the DL_MAP message are shown in Table 2.

TABLE 2

| Syntax | Size |
|---|---|
| Management Message Type=2 | 8 bits |
| PHY Synchronization Field | PHY dependent |
| DCD Count | 16 bits |
| Base Station ID | 48 bits |
| Number of DL-MAP Information Elements n | Variable |
| for(i=1;i<=n;i++) { | |
| DIUC | 4 bits |
| Location Information | PHY dependent |
| } | |

As shown in Table 2, the DL_MAP message includes a plurality of IEs, i.e., a Management Message Type indicating a type of a transmission message, a PHY (Physical) Synchronization Field established according to a modulation scheme and a demodulation scheme applied to a physical channel to acquire synchronization, a DCD Count indicating a count corresponding a variation in configuration of a Downlink Channel Descript message including a downlink burst profile, a Base Station ID indicating a base station identifier, a Number of DL_MAP Elements n indicating the number of elements following the Base Station ID, DIUC, or an MCS level index for an allocated radio resource block, and a Location Information indicating location information of the radio resource block.

IEs included in the UL_MAP message are shown in Table 3.

TABLE 3

| Syntax | Size |
|---|---|
| Management Message Type=3 | 8 bits |
| Uplink Channel ID | 16 bits |
| UCD Count | 16 bits |
| Number of UL-MAP Elements n | Variable |
| Allocation Start Time | 32 bits |
| for(i=1;i<=n;i++) { | |
| CID | 16 bits |
| UIUC | 4 bits |
| Location Info. | PHY dependent |
| } | |

As shown in Table 3, the UL_MAP message includes a plurality of IEs, i.e., a Management Message Type indicating a type of a transmission message, an Uplink Channel ID indicating an uplink channel ID in use, a UCD Count indicating a count corresponding to a variation in configuration of a UCD message including an uplink burst profile, a Number of UL_MAP Elements n indicating the number of elements following the UCD Count, an Allocation Start Time indicating uplink resource allocation time information, UIUC, or an MCS level index for an allocated radio resource block, a Location Information indicting location information of the radio resource block, and a CID indicating a Connection ID of a subscriber station that will use the allocated radio resource block.

Because the DL_MAP message and the UL_MAP message are common control information, the base station 100 transmits the DL_MAP message and the UL_MAP message using the MCS level 4, which is the most robust MCS level, so that the first to fifth subscriber stations 110 to 150 all can normally receive the DL_MAP message and the UL_MAP message. However, the common control information, i.e., the DL_MAP message and the UL_MAP message, includes the information that the first to fifth subscriber stations 110 to 150 all should receive in common, an MCS level index for a radio resource block allocated by the base station 100, and location information of the radio resource block.

That is, in the DL_MAP message, PHY Synchronization, Downlink Channel Descript information, DCD Count, Base Station ID, and Number of DL_MAP Information Elements n are the information that the first to fifth subscriber stations 110 to 150 all should receive in common, but DIUC and Location Information are not the information that the first to fifth subscriber stations 110 to 150 all should receive in common, but the information that only a corresponding subscriber station should receive. In the UL_MAP message, Uplink Channel ID, UCD Count, Number of UL_MAP Elements n, and Allocation Start Time are the information that the first to fifth subscriber stations 110 to 150 all should receive in common, but CID, UIUC and Location Information are not the information that the first to fifth subscriber stations 110 to 150 all should receive in common, but the information that only a corresponding subscriber station should receive.

FIG. 2 is a diagram schematically illustrating application of AMC in a conventional IEEE 802.16a communication system. Before a description of FIG. 2 is given, it will be assumed that the IEEE 802.16a communication system is identical in configuration to the IEEE 802.16a communication system described with reference to FIG. 1. As illustrated in FIG. 2, the base station 100 transmits common control information 211 using the MCS level 0, transmits a first radio resource 213 including data targeting the fourth subscriber station 140 using the MCS level 1, transmits a second radio resource 215 including data targeting the first subscriber station 110 using the MCS level 4, transmits a third radio resource 217 including data targeting the third subscriber station 130 using the MCS level 2, and transmits a fourth radio resource 219 including data targeting the second subscriber station 120 using the MCS level 3. The common control information 211, i.e., the DL_MAP message and the UL_MAP message, includes information on the allocated radio resources, i.e., allocation information for the first to fourth radio resources 213 to 219, and although the allocation information for the first to fourth radio resources 213 to 219 can only be received by corresponding subscriber stations, because it is included in the common control information 211, the base station 100 transmits the allocation information for the first to fourth radio resources 213 to 219 using the MCS level 0, which is the most robust MCS level.

For example, as illustrated in FIG. 2, the base station 100 is allowed to transmit information (i.e., DIUC and Location Information) on a downlink radio resource block targeting only the first subscriber station 110 and information (i.e., CID, UIUC, and Location Information) on an uplink radio resource block in the common control information, i.e., the DL_MAP message and the UL_MAP message, using the MCS level 4, but the base station 100 transmits the information (i.e., DIUC and Location Information) on a downlink radio resource block targeting only the first subscriber station 110 and the information (i.e., CID, UIUC, and Location Information) on an uplink radio resource block using the MCS level 0 because they are also common control information.

As a result, the information (i.e., DIUC and Location Information) on a downlink radio resource block targeting only the first subscriber station 110 and the information (i.e., CID, UIUC, and Location Information) on an uplink radio resource block are transmitted using unnecessarily robust modulation and coding, causing a signaling overhead. Although the information targeting only the first subscriber station 110 has been described by way of example, the information for targeting only any one of the second to fourth subscriber stations 120 to 140 also causes a signaling overhead. As described above, transmitting the common control information using the most robust MCS level undesirably reduces resource efficiency.

### SUMMARY OF THE INVENTION

It is, therefore, an object of the present invention to provide an apparatus and method for transmitting and receiving common control information in a wireless communication system.

It is another object of the present invention to provide an apparatus and method for transmitting and receiving common control information by adaptively selecting AMC according to a characteristic of the common control information in a wireless communication system.

It is further another object of the present invention to provided a common control information transmission and reception apparatus and method for maximizing resource efficiency in a wireless communication system.

In accordance with a first aspect of the present invention, there is provided a method for transmitting common control information from a base station to a plurality of subscriber stations located in a coverage area of the base station in a wireless communication system. The method comprises the steps of generating the common control information including first information that is commonly transmitted to all of the plurality of subscriber stations and second information that is separately transmitted to the plurality of subscriber stations according to channel states of the plurality of subscriber stations, wherein the first information is transmitted using an MCS (Modulation and Coding Scheme) level having a modulation scheme with a lowest order and a coding scheme with a lowest coding rate among all MCS levels available in the base station, and wherein the second information is transmitted using MCS levels that are adjusted by a predetermined level from MCS levels corresponding to the channel states of the plurality of subscriber stations.

In accordance with a second aspect of the present invention, there is provided a method for transmitting common control information from a base station to a plurality of subscriber stations located in a coverage area of the base station in a wireless communication system. The method comprises generating the common control information including first information that is commonly transmitted in common to all of the plurality of subscriber stations and second information that separately transmitted to the plurality of subscriber stations according to channel states of the plurality of subscriber stations, wherein the first information is transmitted using an MCS (Modulation and Coding Scheme) level corresponding to a channel state of a subscriber station having a worst channel state among the plurality of subscriber stations, wherein the second information is transmitted using MCS levels corresponding to the channel states of the plurality of subscriber stations.

In accordance with a third aspect of the present invention, there is provided an apparatus for transmitting common control information from a base station to a plurality of subscriber stations located in a coverage area of the base station in a wireless communication. The apparatus comprises a controller for generating the common control information including first information that is commonly transmitted to all of the plurality of subscriber stations and second information that is separately transmitted to the plurality of subscriber stations according to channel states of the plurality of subscriber stations, selecting an MCS (Modulation and Coding Scheme) level having a modulation scheme with a lowest order and a coding scheme with a lowest coding rate among all MCS levels available in the base station as an MCS level to be applied to the first information, and selecting MCS levels that are adjusted by a predetermined level from the MCS levels corresponding to the channel states of the plurality of subscriber stations as MCS levels to be applied to the second information, an encoder for coding the first information and the second information with the coding schemes corresponding to the MCS levels selected by the controller, a modulator for modulating the first information and the second information coded by the encoder, using modulation schemes corresponding to the MCS levels selected by the controller and a transmitter for converting a signal output from the modulator into a radio frequency (RF) signal, and transmitting the RF signal.

In accordance with a fourth aspect of the present invention, there is provided an apparatus for transmitting common control information from a base station to a plurality of subscriber stations located in a coverage area of the base station in a wireless communication system. The apparatus comprises a controller for generating the common control information including first information that is commonly transmitted to all of the plurality of subscriber stations and second information that is separately transmitted to the plurality of subscriber stations according to channel states of the plurality of subscriber stations, selecting an MCS (Modulation and Coding Scheme) level corresponding to a channel state of a subscriber station having a worst channel state among the plurality of subscriber stations as an MCS level to be applied to the first information, and selecting MCS levels corresponding to the channel states of the plurality of subscriber stations as MCS levels to be applied to the second information, an encoder for coding the first information and the second information using coding schemes corresponding to the MCS levels selected by the controller, a modulator for modulating the first information and the second information coded by the encoder using modulation schemes corresponding to the MCS levels selected by the controller and a transmitter for converting a signal output from the modulator into a radio frequency (RF) signal and transmitting the RF signal.

In accordance with a fifth aspect of the present invention, there is provided a method for receiving common control information transmitted from a base station to a plurality of subscriber stations located in a coverage area of the base station in a wireless communication. The method comprises the steps of demultiplexing a received signal to detect the common control information including first information that all of the plurality of subscriber stations commonly receive and second information that the plurality of subscriber stations separately receive according to channel states of the plurality of subscriber stations, decoding the first information by demodulating and decoding the common control information according to a modulation scheme and a coding scheme corresponding to an MCS (Modulation and Coding Scheme) level applied to the first information in the base station and decoding the second information by demodulating and decoding the common control information according to a modulation scheme and a coding scheme corresponding to MCS levels applied to the second information in the base station.

In accordance with a sixth aspect of the present invention, there is provided an apparatus for receiving common control information transmitted from a base station to a plurality of subscriber stations located in a coverage area of the base station in a wireless communication. The apparatus comprises a receiver for demultiplexing a received signal to detect the common control information including first information that all of the plurality of subscriber stations commonly receive and second information that the plurality of subscriber stations separately receive according to channel states of the plurality of subscriber stations, a demodulator for demodulating the common control information according to a modulation scheme corresponding to an MCS (Modulation and Coding Scheme) level applied to the first information in the base station, and demodulating the common control information according to modulation schemes corresponding to MCS levels applied to the second information and a decoder for decoding the demodulated common control information according to a coding scheme corresponding to an MCS level applied to the first information in the base station, and decoding the demodulated common control information according to the coding schemes corresponding to the MCS levels applied to the second information.

In accordance with a seventh aspect of the present invention, there is provided a method for transmitting common control information from a base station to a plurality of subscriber stations located in a coverage area of the base station in a wireless communication. The method comprises the steps of classifying the plurality of subscriber stations into a plurality of groups according to channel states thereof and transmitting common control information corresponding to the plurality of groups using MCS (Modulation and Coding Scheme) levels corresponding to the channel states of the groups.

In accordance with a eighth aspect of the present invention, there is provided an apparatus for transmitting common control information from a base station to a plurality of subscriber stations located in a coverage area of the base station in a wireless communication system. The apparatus comprises a controller for classifying the plurality of subscriber stations into a plurality of groups according to channel states thereof, and selecting MCS (Modulation and Coding Scheme) levels corresponding to the channel states of the plurality of groups as MCS levels to be applied to the common control information corresponding to each of the plurality of groups, an encoder for coding the common control information using coding schemes corresponding to the MCS levels selected by the controller, a modulator for modulating the common control information coded by the encoder using the modulation schemes corresponding to the MCS levels selected by the controller and a transmitter for converting a signal output from the modulator into a radio frequency (RF) signal, and transmitting the RF signal.

In accordance with a ninth aspect of the present invention, there is provided a method for receiving common control information transmitted from a base station to a plurality of subscriber stations located in a coverage area of the base station in a wireless communication system. The method comprises the steps of demultiplexing a received signal, and detecting common control information that the plurality of subscriber stations receive separately, according to channel states thereof and demodulating and decoding the common control information according to modulation schemes and coding schemes corresponding to MCS (Modulation and Coding Scheme) levels applied to the common control information in the base station.

In accordance with a tenth aspect of the present invention, there is provided an apparatus for receiving common control information transmitted from a base station to a plurality of subscriber stations located in a coverage area of the base station in a wireless communication system. The apparatus comprises a receiver for demultiplexing a received signal, and detecting common control information that the plurality of subscriber stations receive separately, according to channel states thereof, a demodulator for demodulating the common control information according to modulation schemes corresponding to MCS (Modulation and Coding Scheme) levels applied to the common control information in the base station and a decoder for decoding the demodulated common control information according to coding schemes corresponding to the MCS levels.

In accordance with a tenth aspect of the present invention, there is provided a method for transmitting common control information from a base station to a plurality of subscriber stations located in a coverage area of the base station in a wireless communication. The method comprises the steps of classifying the plurality of subscriber stations into a plurality of groups according to channel states thereof, generating a first common control information that is commonly transmitted in common to all of the plurality of subscriber stations, wherein the first common control information is placed with a lower rate coding and modulation before other information and generating a second common control information that is separately transmitted to a plurality of groups, wherein each of the second common control information has a different modulation and coding rate.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram schematically illustrating a conventional IEEE 802.16a communication system;

FIG. 2 is a diagram schematically illustrating application of an AMC scheme in a conventional IEEE 802.16a communication system;

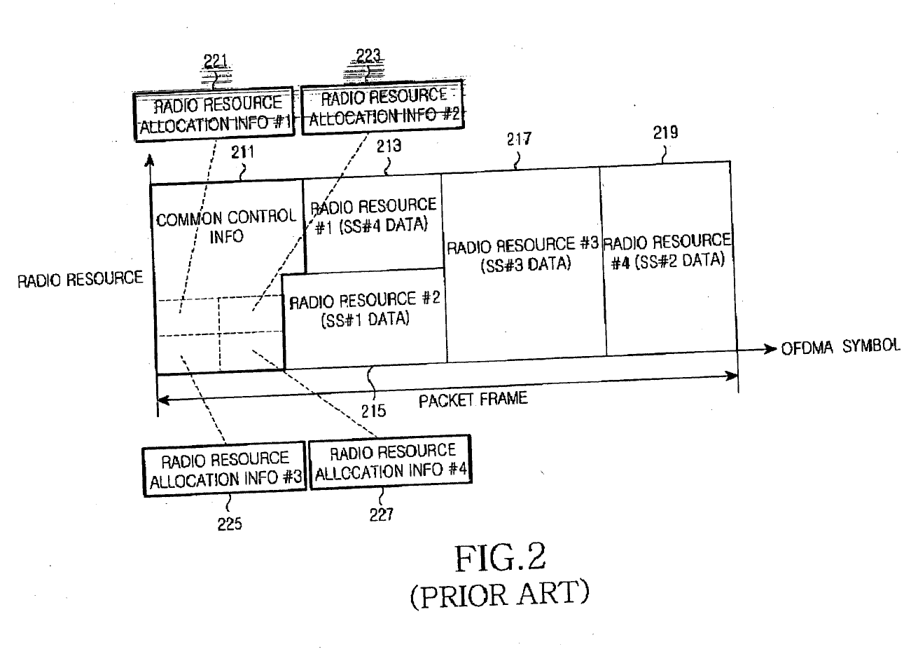

FIG. 3 is a diagram schematically illustrating application of an AMC scheme in an IEEE 802.16a communication system according to an embodiment of the present invention;

FIG. 4 is a diagram schematically illustrating a transmitter for an IEEE 802.16a communication system according to the present invention;

FIG. 5 is a diagram schematically illustrating a receiver in an IEEE 802.16a communication system according to the present invention;

FIG. 6 is a flowchart illustrating a process of transmitting common control information in an IEEE 802.16a communication system according to the present invention;

FIG. 7 is a flowchart illustrating a process of receiving common control information in an IEEE 802.16a communication system according to the present invention;

FIG. 8 is a diagram illustrating a frame format for an IEEE 802.16a communication system according to the present invention; and

FIG. 9 is a diagram schematically illustrating application of AMC scheme in an IEEE 802.16a communication system according to the present invention.

### DETAILED DESCRIPTION OF THE PREFERRED EMBODIMENT

Several preferred embodiments of the present invention will now be described in detail herein below with reference to the annexed drawings. In the drawings, the same or similar elements are denoted by the same reference numerals even though they are depicted in different drawings. Additionally, in the following description, a detailed description of known functions and configurations incorporated herein has been omitted for conciseness.

The present invention proposes an apparatus and method for increasing resource efficiency by transmitting common control information (CCI) that all subscriber stations (SSs) should commonly receive according to a characteristic of the common control information and channel states of the subscriber stations, using an Adaptive Modulation and Coding (AMC) scheme in a wireless communication system.

In the following description, an Institute of Electrical and Electronics Engineers (IEEE) 802.16a communication system defined by applying an Orthogonal Frequency Division Multiplexing (OFDM) scheme and/or an Orthogonal Frequency Division Multiple Access (OFDMA) scheme to a Metropolitan Area Network (MAN) communication system, which is a Broadband Wireless Access (BWA) communication system, is used as an example of the wireless communication system.

As described above, the AMC scheme is a scheme for transmitting a signal using different Modulation and Coding Schemes (MCSs) according to channel states between a base station (BS) and subscriber stations. That is, the AMC scheme is a signal transmission scheme for selecting different modulation scheme and coding schemes according to channel states between a cell, or a base station, and subscriber stations, thereby improving efficiency of the entire cell. The AMC scheme has a plurality of modulation schemes and a plurality of coding schemes, and modulates/codes a channel signal with a combination of the modulation schemes and coding schemes. Commonly, each of the combinations of the modulation schemes and coding schemes is called “MCS,” and it is possible to define a plurality of MCSs of level 1 to level N according to the number of MCSs. More specifically, the AMC scheme is a scheme for adaptively selecting an MCS level according to the channel states between the base station and the subscriber stations, thereby improving efficiency of the entire base station system.

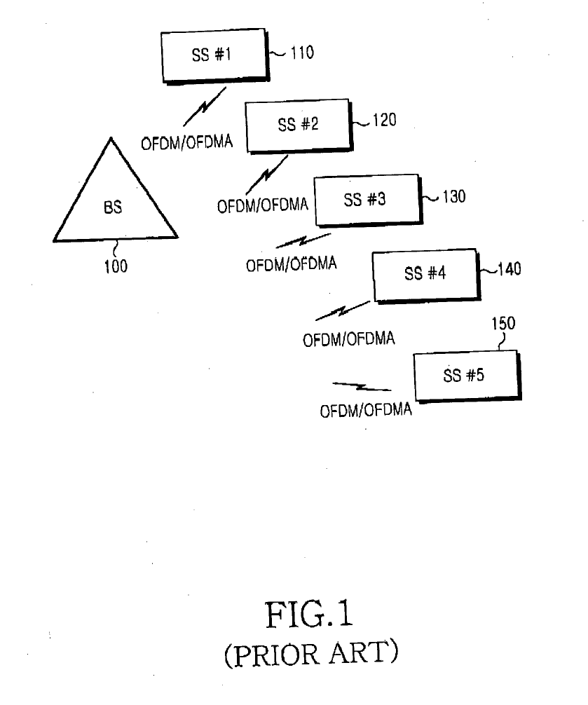

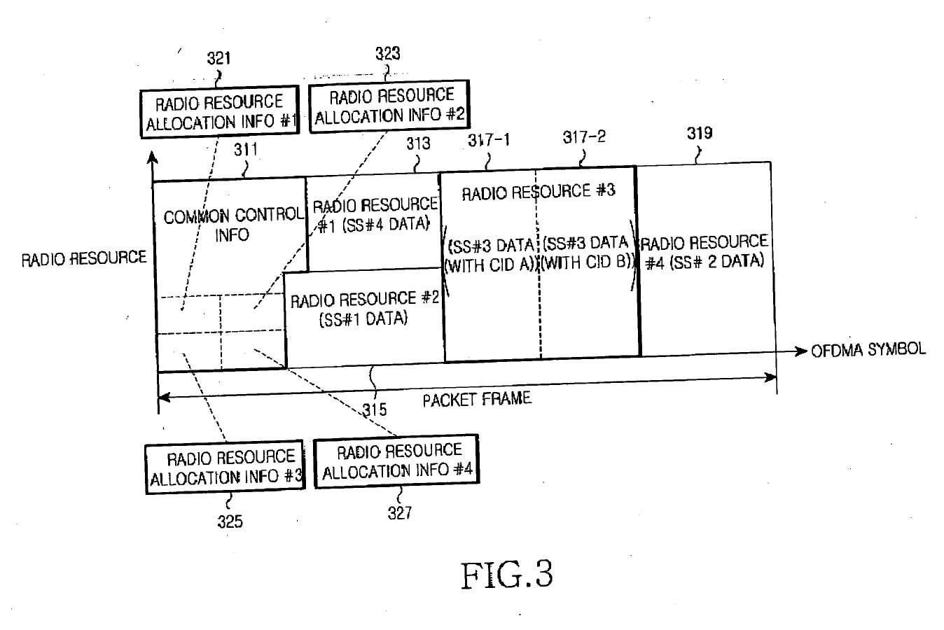

FIG. 3 is a diagram schematically illustrating application of the AMC scheme in the IEEE 802.16a communication system according to the present invention. Before a description of FIG. 3 is given, it will be assumed that the IEEE 802.16a communication system is identical in configuration to the IEEE 802.16a communication system described with reference to FIG. 1, except that one subscriber station, i.e., a sixth subscriber station (not shown), is located in the same place as the third subscriber station 130.

As described with reference to FIG. 1, the first subscriber station 110 having the shortest distance from the base station 100 has the best channel state, and the fifth subscriber station 150 having the longest distance from the base station 100 has the worst channel state. In addition, as described with reference to FIG. 1, the channel states will be distinguished into 5 states: ‘best’ state, ‘good’state, ‘normal’ state, ‘bad’ state, and ‘worst’ state. In addition, it will be assumed that the IEEE 802.16a communication system has 5 MCS levels of an MCS level 0 to an MCS level 4 as described with reference to Table 1.

The common control information can include the downlink MAP (DL_MAP) message and the uplink MAP (UL_MAP) message described with reference to Table 2 and Table 3, or a Hybrid Automatic Retransmission Request MAP (HARQ_MAP) message. The HARQ_MAP message includes a compact DL_MAP message and a compact UL_MAP message including some of the information elements (IEs) included in the DL_MAP message and the UL_MAP message. The IEs included in the compact DL_MAP message and the compact UL_MAP message are not directly related to the present invention, and a detailed description thereof will be omitted herein.

As described above, in the DL_MAP message, PHY (Physical) Synchronization established according to a modulation scheme and a demodulation scheme applied to a physical channel to acquire synchronization, Downlink Channel Descriptor (DCD) information, DCD Count indicating a count corresponding a variation in configuration of a DCD message including a downlink burst profile, Base Station ID indicating a base station identifier, and Number of DL_MAP Elements n indicating the number of elements following the Base Station ID are the information that all subscriber stations serviced by the base station 100 should receive in common, but DIUC (Downlink Interval Usage Code), or an MCS level index for an allocated radio resource block, and Location Information indicating location information of the radio resource block are not the information that all of the subscriber stations should receive in common, rather the information that only a corresponding subscriber station should receive.

In the UL_MAP message, an Uplink Channel ID indicating an uplink channel ID in use, a UCD Count indicating a count corresponding to a variation in configuration of a UCD (Uplink Channel Descriptor) message including an uplink burst profile, a Number of UL_MAP Elements n indicating the number of elements following the UCD Count, and an Allocation Start Time indicating uplink resource allocation time information are the information that all of the subscriber stations should receive in common, but UIUC (Uplink Interval Usage Code), or an MCS level index for an allocated radio resource block, Location Information indicting location information of the radio resource block, and CID(Connection ID(IDentifier) indicating a Connection ID of a subscriber station that will use the allocated radio resource block are not the information that all of the subscriber stations should receive in common, but the information that only a corresponding subscriber station should receive. The HARQ_MAP message is not the information that all of the subscriber stations should receive in common, but the information that only corresponding subscriber stations, i.e., subscriber station having the same channel state, should receive.

Referring to FIG. 3, in transmitting common control information 311, the base station 100 transmits the information that all subscriber stations serviced by the base station 100 should receive in common, using the MCS level 0, which is the most robust MCS level, and transmits the information that only a corresponding subscriber station should receive, using an MCS level determined according to a channel state of the corresponding subscriber station. An operation of allocating an MCS level for the information that only a corresponding subscriber station should receive, in the common control information 311, will be described afterward.

The base station 100 transmits a first radio resource 313 including data targeting the fourth subscriber station 140 using the MCS level 1, and transmits a second radio resource 315 including data targeting the first subscriber station 110 using the MCS level 4. Further, the base station 100 transmits a third radio resource 317 including data targeting the third subscriber station 130 and the sixth subscriber station using the MCS level 2, and transmits a fourth radio resource 319 including data targeting the second subscriber station 120 using the MCS level 3. Herein, the third radio resource 317 includes a part allocated to the third subscriber station 130 and the other part allocated to the sixth subscriber station, such that it is transmitted together with a CID for identifying a target of the data.

The base station 100 selects an MCS level according to a channel state of a corresponding subscriber station for the information that only the corresponding subscriber station should receive, in the common control information 311. However, because even the information that only the corresponding subscriber station should receive should be guaranteed to have higher reliability than that of normal data other than the control information, the present invention transmits the corresponding information using an MCS level that is lower by 1 level than an MCS level corresponding to a channel state of the corresponding subscriber station. Alternatively, the base station 100 can transmit the information using an MCS level corresponding to a channel state of the corresponding subscriber station. In this case, only the reliability is lowered as compared with when the base station 100 transmits the information using the 1-level-lower MCS level.

The base station 100 transmits first radio resource allocation information 321, which is to be transmitted only to the fourth subscriber station 140, using the MCS level 0, transmits second radio resource allocation information 323, which is to be transmitted only to the first subscriber station 110, using the MCS level 3, transmits third radio resource allocation information 325, which is to be transmitted only to the third subscriber station 130 and the sixth subscriber station, using the MCS level 1, and transmits fourth radio resource allocation information 327, which is to be transmitted only to the second subscriber station 120, using the MCS level 2.

That is, the present invention classifies a characteristic of the common control information 311 according to whether all subscriber stations should receive it or only a corresponding subscriber station should receive it. The present invention transmits the information that all subscriber stations should receive, using the most robust MCS level, i.e., the MCS level 0, and transmits the information that only a corresponding subscriber station should receive, using an MCS level which is lower by a predetermined level, for example, 1 level, than an MCS level corresponding to a channel state of the corresponding subscriber station, thereby increasing both reliability and resource efficiency.

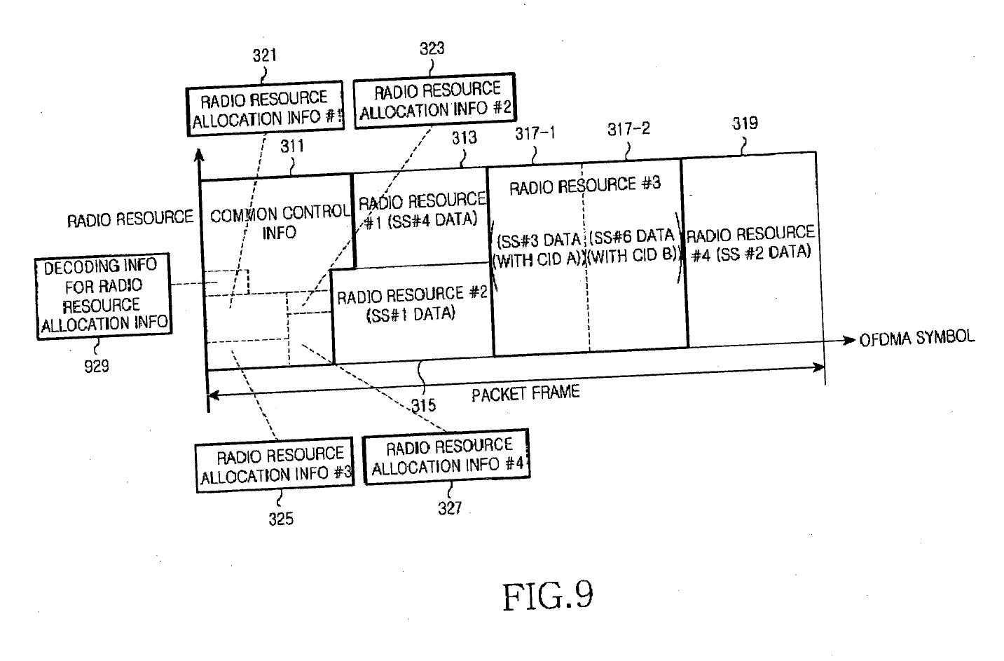

FIG. 9 is a diagram schematically illustrating application of AMC in the IEEE 802.16a communication system according to another embodiment of the present invention. Before a description of FIG. 9 is given, it will be assumed that the IEEE 802.16a communication system is identical in configuration to the IEEE 802.16a communication system described with reference to FIG. 3. That is, as described with reference to FIG. 3, the first subscriber station 110 having the shortest distance from the base station 100 has the best channel state, and the fifth subscriber station 150 having the longest distance from the base station 100 has the worst channel state. Also, the sixth subscriber station is located in the same place where the third subscriber station 130 is located, as described with reference to FIG. 3.

The first embodiment of the present invention has not separately prescribed the information that all subscriber stations should receive in common, in the common control information. However, in order for subscriber stations to normally receive radio resource information, which is allocation information for radio resources allocated to the corresponding subscriber stations, decoding information for normally decoding the radio resource allocation information should be included in the common control information. Additionally, because the radio resource allocation information is coded according to an MCS level determined depending on a channel state of a corresponding subscriber station, a size and location of the radio resource allocation information is different for respective subscriber stations. Therefore, the base station should inform the subscriber station of the size and location of the radio resource allocation information through the common control information. The subscriber station reads the decoding information and decodes the radio resource allocation information with an MCS level corresponding to the size and location of the corresponding radio resource allocation information. Herein, the term “decoding information” for the radio resource allocation information refers to an MCS level and size and location information of radio resource allocation information corresponding to the MCS level.

Referring to FIG. 9, the second embodiment of the present invention is almost identical to the first embodiment of the present invention in method of using AMC, except that the decoding information 929 for the radio resource allocation information is added to the common control information 311 described in connection with FIG. 3. As described above, because MCS levels actually used for radio resource information are different, the first and second embodiments are different only in that sizes or locations of the first radio resource allocation information 321 to the fourth radio resource allocation information 327 are different. Therefore, a detailed description of the same parts as those illustrated in FIG. 3 will be omitted herein.

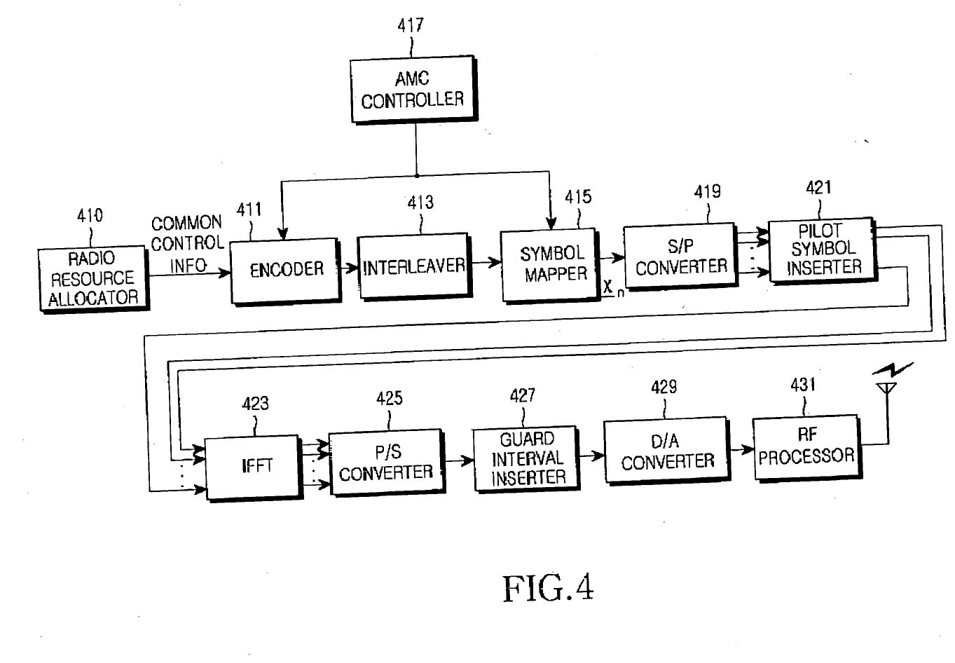

FIG. 4 is a diagram schematically illustrating a structure of a transmitter for the IEEE 802.16a communication system according to the present invention. Referring to FIG. 4, the transmitter, or a base station, includes a radio resource allocator 410, an encoder 411, an interleaver 413, a symbol mapper 415, an AMC controller 417, a serial-to-parallel (S/P) converter 419, a pilot symbol inserter 421, an inverse fast Fourier transform (IFFT) unit 423, a parallel-to-serial (P/S) converter 425, a guard interval inserter 427, a digital-to-analog (D/A) converter 429, and a radio frequency (RF) processor 431.

The radio resource allocator 410 allocates downlink and uplink resources for receivers, or subscriber stations, generates common control information according to the allocated downlink and uplink resources, and outputs the generated common control information to the encoder 411. A process of allocating downlink and uplink resources for the subscriber stations by the radio resource allocator 410 is not directly related to the present invention, and a detailed description thereof will be omitted. The encoder 411 codes the common control information using a coding scheme controlled by the AMC controller 417, and outputs the coded common control information to the interleaver 413.

The AMC controller 417 selects a coding scheme corresponding to the most robust MCS level for the information that all subscriber stations should receive, in the common control information, and selects a coding scheme corresponding to an MCS level, which is lower by 1 level than an MCS level corresponding to a channel state of a corresponding subscriber station for the information that only the corresponding subscriber station should receive, in the common control information. For example, it is assumed herein that the coding scheme is a coding rate. The interleaver 413 interleaves the coded common control information using a predetermined interleaving scheme, and outputs the interleaved common control information to the symbol mapper 415. Herein, a random interleaving scheme can be used for the interleaving scheme.

The symbol mapper 415 modulates coded bits output from the interleaver 413 into modulation symbols using a modulation scheme controlled by the AMC controller 417, and outputs the modulation symbols to the serial-to-parallel converter 419. Herein, Quadrature Phase Shift Keying (QPSK) or 16-ary Quadrature Amplitude Modulation (16QAM) can be used for the modulation scheme, and the AMC controller 417 selects a modulation scheme corresponding to the most robust MCS level for the information that all subscriber stations should receive, in the common control information, and selects a modulation scheme corresponding to an MCS level which is lower by 1 level than an MCS level corresponding to a channel state of a corresponding subscriber station for the information that only the corresponding subscriber station should receive, in the common control information.

The serial-to-parallel converter 419 parallel-converts serial modulation symbols output from the symbol mapper 415, and outputs the parallel-converted modulation symbols to the pilot symbol inserter 421. The pilot symbol inserter 421 inserts pilot symbols into the parallel-converted modulation symbols output from the serial-to-parallel converter 419, and outputs the pilot-inserted modulation symbols to the IFFT unit 423.

The IFFT unit 423 performs N-point IFFT on the signals output from the pilot symbol inserter 421, and outputs the IFFT-processed signals to the parallel-to-serial converter 425. The parallel-to-serial converter 425 serial-converts the signals output from the IFFT unit 423, and outputs the serial-converted signal to the guard interval inserter 427. The guard interval inserter 427 inserts a guard interval signal into the signal output from the parallel-to-serial converter 425, and outputs the guard interval-inserted signal to the digital-to-analog converter 429. The guard interval is inserted to remove interference between an OFDM symbol transmitted at a previous time and an OFDM symbol transmitted at a current time. The guard interval signal is inserted in a cyclic prefix scheme or a cyclic prefix scheme. In the cyclic prefix scheme, a predetermined number of last samples of an OFDM symbol in a time domain are copied and inserted into a valid OFDM symbol, and in the cyclic postfix scheme, a predetermined number of first samples of an OFDM symbol in a time domain are copied and inserted into a valid OFDM symbol.

The digital-to-analog converter 429 analog-converts the signal output from the guard interval inserter 427, and outputs the analog-converted signal to the RF processor 431. The RF processor 431, including a filter and a front-end unit, RF-processes the signal output from the digital-to-analog converter 429, such that the signal can be actually transmitted over the air, and transmits the RF-processed signal over the air via a transmission antenna.

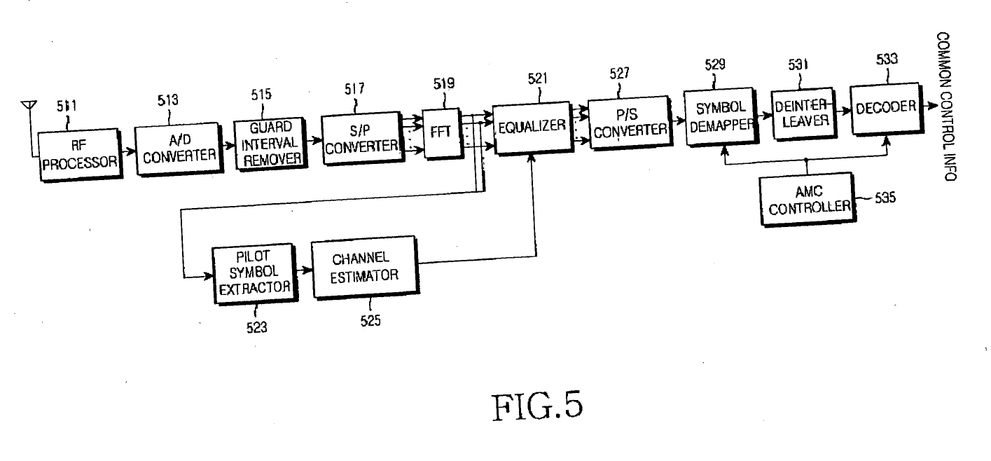

FIG. 5 is a diagram schematically illustrating a receiver in the IEEE 802.16a communication system according to the present invention. Referring to FIG. 5, the receiver, or a subscriber station, includes an RF processor 511, an analog-to-digital (A/D) converter 513, a guard interval remover 515, a serial-to-parallel (S/P) converter 517, a fast Fourier transform (FFT) unit 519, an equalizer 521, a pilot symbol extractor 523, a channel estimator 525, a parallel-to-serial (P/S) converter 527, a symbol demapper 529, a deinterleaver 531, a decoder 533, and an AMC controller 535.

A signal transmitted by the transmitter, or the base station, in the IEEE 802.16a communication system described with reference to FIG. 4, is received via a reception antenna of the receiver, the received signal experiencing a multipath channel and having a noise component. The signal received via the reception antenna is input to the RF processor 511, which down-converts the signal received via the reception antenna into an intermediate frequency (IF) signal and outputs the IF signal to the analog-to-digital converter 513. The analog-to-digital converter 513 digital-converts an analog signal output from the RF processor 511, and outputs the digital-converted signal to the guard interval remover 515.

The guard interval remover 515 removes a guard interval signal from the digital-converted signal output from the analog-to-digital converter 513, and outputs the guard interval-removed signal to the serial-to-parallel converter 517. The serial-to-parallel converter 517 parallel-converts the serial signal output from the guard interval remover 515, and outputs the parallel-converted signal to the FFT unit 519. The FFT unit 519 performs N-point FFT on the signal output from the serial-to-parallel converter 517, and outputs the FFT-processed signal to the equalizer 521 and the pilot symbol extractor 523. The equalizer 521 channel-equalizes the signal output from the FFT unit 519, and outputs the channel-equalized signal to the parallel-to-serial converter 527. The parallel-to-serial converter 527 serial-converts the parallel signal output from the equalizer 521, and outputs the serial-converted signal to the symbol demapper 529.

The FFT-processed signal output from the IFFT unit 519 is input to the pilot symbol extractor 523, and the pilot symbol extractor 523 extracts pilot symbols from the FFT-processed signal output from the FFT unit 519, and outputs the extracted pilot symbols to the channel estimator 525. The channel estimator 525 performs channel estimation on the extracted pilot symbols output from the pilot symbol extractor 523, and outputs the channel estimation result to the equalizer 521. The subscriber station generates channel quality information (CQI) corresponding to the channel estimation result from the channel estimator 525, and transmits the generated CQI to the base station through a CQI transmitter (not shown).

The symbol demapper 529 demodulates the signal output from the parallel-to-serial converter 527 using a demodulation scheme corresponding to the modulation scheme used in the base station, and outputs the demodulated signal to the deinterleaver 531. Information on the modulation scheme used in the base station is provided from the AMC controller 535, and although not illustrated in FIG. 5, the AMC controller 535 is provided with separate information on the modulation scheme from the base station. The deinterleaver 531 deinterleaves the signal output from the symbol demapper 529 using a deinterleaving scheme corresponding to the interleaving scheme used in the base station, and outputs the deinterleaved signal to the decoder 533.

The decoder 533 decodes the deinterleaved signal output from the deinterleaver 531 using a decoding scheme corresponding to the coding scheme used in the base station, and outputs the decoded signal as common control information transmitted by the transmitter. Also, information on the coding scheme used in the base station is provided from the AMC controller 535, and although not illustrated in FIG. 5, the AMC controller 535 is provided with separate information on the coding scheme from the base station.

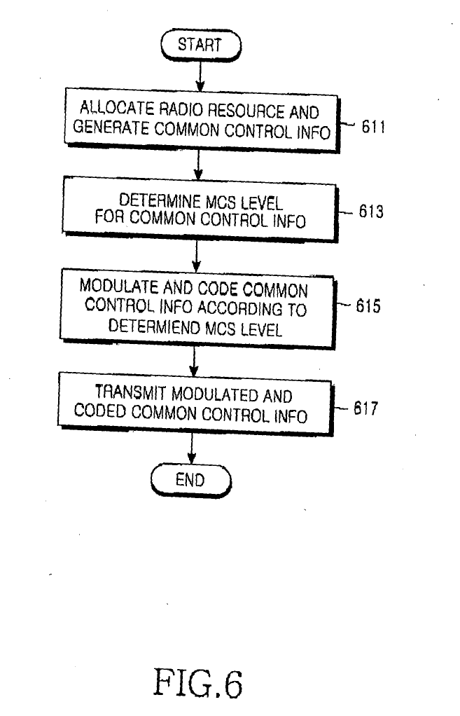

FIG. 6 is a flowchart illustrating a process of transmitting common control information in the IEEE 802.16a communication system according to the present invention. Referring to FIG. 6, in step 611, a transmitter, or a base station, of the IEEE 802.16a communication system allocates downlink and uplink resources for a receiver, or a subscriber station, of the IEEE 802.16a communication system, and generates common control information according to the allocated downlink and uplink resources. In step 613, the base station selects an MCS level to be used for the common control information. Herein, in selecting the MCS level for the common control information, the base station selects the most robust MCS level for the information that all subscriber stations should receive, in the common control information, and selects an MCS level which is lower by 1 level than an MCS level corresponding to a channel state of a corresponding subscriber station for the information that only the corresponding subscriber station should receive, in the common control information.

More specifically, in the second embodiment of the present invention, the base station includes decoding information for normally decoding the information that only the corresponding subscriber station should receive, i.e., radio resource allocation information, in the common control information, because the radio resource allocation information blocks are coded with different MCS levels.

In step 615, the base station modulates and codes the common control information according to the selected MCS level, and then proceeds to step 617. In step 617, the base station transmits the modulated coded common control information to subscriber stations through a downlink, and then ends the process.

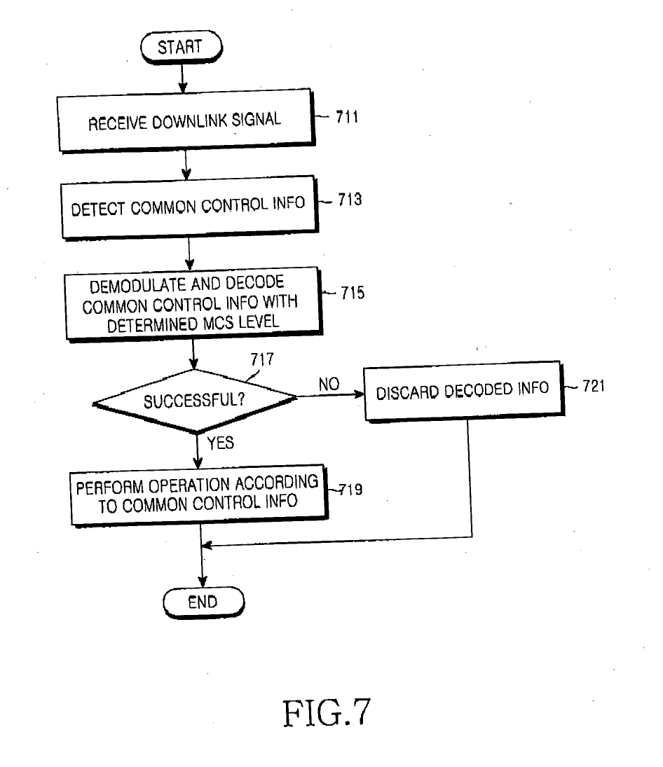

FIG. 7 is a flowchart illustrating a process of receiving common control information in the IEEE 802.16a communication system according to the present invention. Referring to FIG. 7, in step 711, a receiver, or a subscriber station, of the IEEE 802.16a communication system receives a downlink signal. In step 713, the subscriber station detects common control information by multiplexing the received downlink signal. More specifically, in the second embodiment of the present invention, decoding information for decoding radio resource allocation information is included in the common control information.

In step 715, the subscriber station demodulates and decodes the detected common control information according to an MCS level used in a base station.

More specifically, in the second embodiment of the present invention, the subscriber station demodulates and decodes the detected common control information according to an MCS level used in the base station by a corresponding size in the location of radio resource allocation information that the subscriber station itself should decode according to the decoding information. In this case, the subscriber station can decode the radio resource allocation information at higher reliability.

In step 717, the subscriber station determines if decoding on the common control information is successful. If it is determined that decoding on the common control information is successful, in step 719, the subscriber station performs an operation corresponding to the common control information, i.e., a data reception operation through a radio resource field corresponding to radio resource information included in the common control information, and then ends the process. However, if it is determined in step 717 that decoding on the common control information is not successful, in step 721, the subscriber station discards the decoded information, and ends the process.

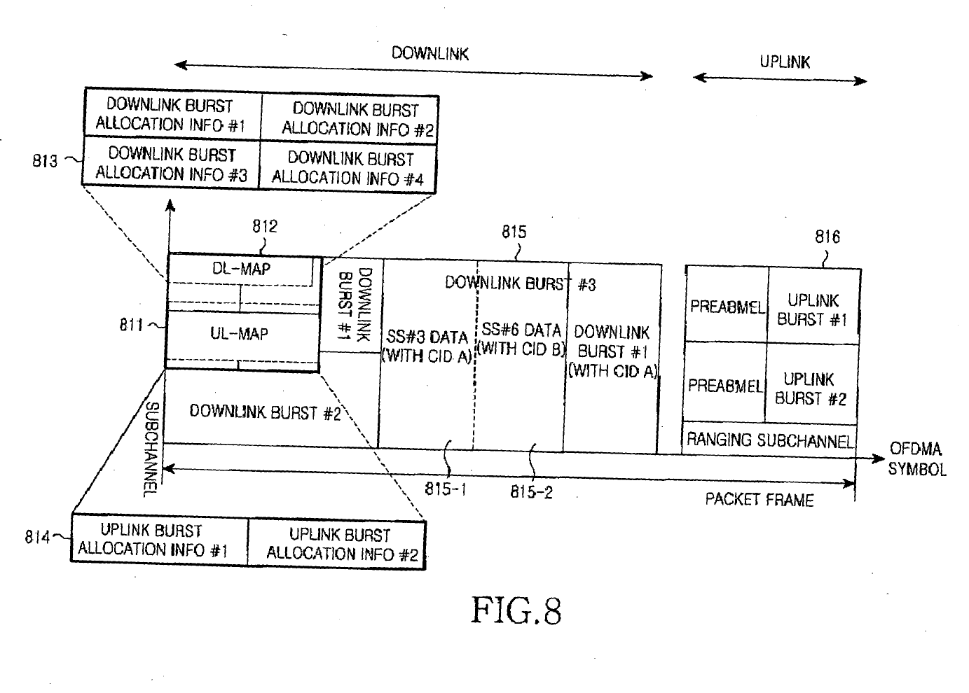

FIG. 8 is a diagram illustrating a frame format for the IEEE 802.16a communication system according to the first embodiment of the present invention. Referring to FIG. 8, a horizontal axis represents an OFDMA symbol number, and a vertical axis represents a subchannel number. As illustrated in FIG. 8, one OFDMA frame includes a plurality of, for example, 8 OFDMA symbols. One OFDMA symbol includes a plurality of, for example, N subcarrier signals. Herein, the term “subchannel” refers to a channel including a predetermined number of subcarriers. In addition, as described above, the common control information includes a DL_MAP message and a UL_MAP message, or an HARQ_MAP message, and it will be assumed in FIG. 8 that the common control information includes the DL_MAP message and the UL_MAP message.

In addition, FIG. 8 illustrates two cases, i.e., a first case in which the base station 100 transmits common control information and user data to the third subscriber station 130 having a ‘normal’ channel state and the third subscriber station 130 receives the common control information and the user data, and a second case where the base station 100 transmits common control information to the first subscriber station 110 having a ‘best’ channel state and the first subscriber station 110 transmits user data over an uplink.

The base station 100 allocates user data 815-1 of the third subscriber station 130 including a CID A and user data 815-2 of the sixth subscriber station including a CID B, both the third and sixth subscriber stations using the same QoS (Quality-of-Service) level and the same MCS level, to a third downlink burst 815. In the same method, the base station 100 allocates user data and CID of a corresponding subscriber station for each downlink burst needed in one OFDMA frame within an MCS level supported in the IEEE 802.16a communication system.

In addition, the base station 100 maps offset information in units of symbols or subcarrier frequency allocation capable of distinguishing a downlink burst transmitted to the third subscriber station 130, i.e., an MCS level and position information to be used for the third downlink burst 815, to third downlink burst allocation information 813 in the DL_MAP message 812, which is common control information.

Although not separately illustrated in FIG. 8, in the second embodiment of the present invention, the common control information includes decoding information for decoding radio resource allocation information, i.e., an MCS level and location and size information of radio resource allocation information corresponding to the MCS level. Thereafter, the base station 100 codes and modulates the DL_MAP message 812 and downlink bursts using the corresponding MCS level, and transmits the results to subscriber stations.

The third subscriber station 130 receives a downlink signal and detects common control information from the received downlink signal. That is, the third subscriber station 130 detects the information that all subscriber stations should receive, i.e., PHY Synchronization, DCD Count, Base Station ID, and Number of DL_MAP Elements n, from the DL_MAP message described in connection with Table 2, by applying the most robust MCS level to the detected common control information. Thereafter, the third subscriber station 130 demodulates and decodes the detected common control information using an MCS level, which is 1 level lower than an MCS level corresponding to a channel state of the third subscriber station 130, in order to acquire downlink burst allocation information for the downlink bursts.

More specifically, the third subscriber station 130 decodes first downlink burst allocation information using an MCS level, which is lower by 1 level than an MCS level corresponding to its channel state. However, the third subscriber station 130 fails in decoding due to a difference of the MCS level used for the first downlink burst allocation information, such that it discards the corresponding information. Accordingly, the third subscriber station 130 decodes second downlink burst allocation information, third downlink burst allocation information 813, and fourth downlink burst allocation information. Because only the third downlink burst allocation information 813 uses the same MCS level, only the third downlink burst allocation information 813 is normally decoded. Therefore, the third subscriber station 130 accesses a downlink burst corresponding to the third downlink burst allocation information 813, i.e., the third downlink burst 815, and demodulates user data using the same MCS level as an MCS level corresponding to its channel state.

Although not illustrated in FIG. 8, in the second embodiment of the present invention, the third subscriber station 130 detects decoding information for decoding the third downlink burst allocation information 813 representing a location of the third downlink burst 815 from the common control information, and detects location and size of downlink burst allocation information having an MCS level applied thereto. Therefore, the third subscriber station 130 decodes the third downlink burst allocation information 813 with reliability according to the decoding information. That is, the third subscriber station 130 detects the same MCS level as its own MCS level from the decoding information, and decodes information on the corresponding location using the detected MCS level. Accordingly, the third subscriber station 130 normally decodes the third downlink burst allocation information 813.

Further, in demodulating the user data, the third subscriber station 130 should refer to its own CID, i.e., CID A.

Uplink burst allocation information can be detected in the method used in detecting the downlink burst allocation information. More specifically, the base station 100 allocates a first uplink burst 816 to the first subscriber station 110 in order to transmit user data to the first subscriber station 110 over an uplink. That is, the base station 100 maps offset information in units of symbol or subcarrier frequency allocation capable of distinguishing an MCS level and position information of the first uplink burst 816, i.e., the uplink burst, together with a CID C of the first subscriber station 110, to the UL_MAP message 811. Thereafter, the base station 100 codes and modulates the UL_MAP message 811 using a corresponding MCS level, and transmits the modulated UL_MAP message to subscriber stations.

Therefore, the first subscriber station 110 receives a downlink signal, and detects common control information from the received downlink signal. That is, the first subscriber station 110 detects the information that all subscriber stations should receive, i.e., Uplink Channel ID, UCD Count, Allocation Start Time, and Number of UL_MAP Elements n, from the UL_MAP message 811 described in connection with Table 3, by applying the most robust MCS level to the detected common control information.

Although not illustrated in FIG. 8, in the second embodiment of the present invention, the common control information includes the decoding information, i.e., an MCS level and location and size information for each of uplink burst allocation information corresponding to the MCS level. Thereafter, the first subscriber station 110 demodulates and decodes the detected common control information using an MCS level, which is lower by 1 level than an MCS level corresponding to a channel state of the first subscriber station 110, in order to acquire uplink burst allocation information for the uplink bursts.

More specifically, the first subscriber station 110 decodes first uplink burst allocation information 814 using an MCS level, which is lower by 1 level than an MCS level corresponding to its channel state. Because the MCS level applied to the first uplink burst allocation information 814 is identical to the MCS level, which is lower by 1 level than the MCS level corresponding to a channel state of the first subscriber station 110, the first subscriber station 110 can normally decode the first uplink burst allocation information. Therefore, the first subscriber station 110 can use an uplink burst according to the first uplink burst allocation information 814, i.e., the first uplink burst 816.

Although not illustrated in FIG. 8, in the second embodiment of the present invention, the first subscriber station 110 detects decoding information for decoding the first uplink burst allocation information 814 representing a location of the first uplink burst 816 from the common control information, and decodes uplink burst allocation information having an MCS level for the first subscriber station 110, i.e., the first uplink burst allocation information 814, according to the decoding information.

As can be understood from the forgoing description, the wireless communication system of the present invention classifies common control information into the information that all subscriber stations should receive in common and the information that only particular subscriber stations should receive, and transmits the classified information using different MCS levels, thereby maximizing efficiency of radio resources. As a result, the amount of radio resources used for transmission of common control information is minimized, and spare radio resources secured by the minimization are used for transmitting other data, thereby improving performance of the wireless communication system.

While the present invention has been shown and described with reference to certain preferred embodiments thereof, it will be understood by those skilled in the art that various changes in form and details may be made therein without departing from the spirit and scope of the present invention as defined by the appended claims.

1. A method for transmitting common control information from a base station to a plurality of subscriber stations located in a coverage area of the base station in a wireless communication system, comprising the steps of:
generating the common control information including first information that is commonly transmitted to all of the plurality of subscriber stations and second information that is separately transmitted to the plurality of subscriber stations according to channel states of the plurality of subscriber stations;
wherein the first information is transmitted using an MCS (Modulation and Coding Scheme) level having a modulation scheme with a lowest order and a coding scheme with a lowest coding rate among all MCS levels available in the base station; and
wherein the second information is transmitted using MCS levels that are adjusted by a predetermined level from MCS levels corresponding to the channel states of the plurality of subscriber stations.

2. The method of claim 1, wherein the first information includes MCS levels applied to the second information, and location and size information of information corresponding to each of the MCS levels.

3. The method of claim 2, wherein the MCS levels that are adjusted by the predetermined level from the MCS levels corresponding to the channel states of the plurality of subscriber stations are identical to one of the MCS levels corresponding to channel states of the subscriber stations and MCS levels having modulation schemes with a lower order than that of the modulation schemes of the MCS levels corresponding to the channel states of the subscriber stations, and have coding schemes with lower coding rates than coding schemes of MCS levels corresponding to channel states of the plurality of subscriber stations for the coding schemes for the level-adjusted MCS levels.

4. A method for transmitting common control information from a base station to a plurality of subscriber stations located in a coverage area of the base station in a wireless communication system, comprising:
generating the common control information including first information that is commonly transmitted in common to all of the plurality of subscriber stations and second information that separately transmitted to the plurality of subscriber stations according to channel states of the plurality of subscriber stations;
wherein the first information is transmitted using an MCS (Modulation and Coding Scheme) level corresponding to a channel state of a subscriber station having a worst channel state among the plurality of subscriber stations;
wherein the second information is transmitted using MCS levels corresponding to the channel states of the plurality of subscriber stations.

5. The method of claim 4, wherein the first information includes MCS levels applied to the second information, and location and size information of information corresponding to each of the MCS levels.

6. An apparatus for transmitting common control information from a base station to a plurality of subscriber stations located in a coverage area of the base station in a wireless communication, comprising:
a controller for generating the common control information including first information that is commonly transmitted to all of the plurality of subscriber stations and second information that is separately transmitted to the plurality of subscriber stations according to channel states of the plurality of subscriber stations, selecting an MCS (Modulation and Coding Scheme) level having a modulation scheme with a lowest order and a coding scheme with a lowest coding rate among all MCS levels available in the base station as an MCS level to be applied to the first information, and selecting MCS levels that are adjusted by a predetermined level from the MCS levels corresponding to the channel states of the plurality of subscriber stations as MCS levels to be applied to the second information;
an encoder for coding the first information and the second information with the coding schemes corresponding to the MCS levels selected by the controller;
a modulator for modulating the first information and the second information coded by the encoder, using modulation schemes corresponding to the MCS levels selected by the controller; and
a transmitter for converting a signal output from the modulator into a radio frequency (RF) signal, and transmitting the RF signal.

7. The apparatus of claim 6, wherein the first information includes MCS levels applied to the second information, and location and size information of information corresponding to each of the MCS levels.

8. The apparatus of claim 6, wherein the MCS levels that are adjusted by the predetermined level against the MCS levels corresponding to the channel states of the plurality of subscriber stations are identical to one of the MCS levels corresponding to the channel states of the plurality of subscriber stations, and MCS levels having modulation schemes with a lower order than that of the modulation schemes of the MCS levels corresponding to the channel states of the plurality of subscriber stations, and have coding schemes with lower coding rates than that of coding schemes of the MCS levels corresponding to the channel states of the plurality of subscriber stations for the coding schemes for the level-adjusted MCS levels.

9. An apparatus for transmitting common control information from a base station to a plurality of subscriber stations located in a coverage area of the base station in a wireless communication system, comprising:
a controller for generating the common control information including first information that is commonly transmitted to all of the plurality of subscriber stations and second information that is separately transmitted to the plurality of subscriber stations according to channel states of the plurality of subscriber stations, selecting an MCS (Modulation and Coding Scheme) level corresponding to a channel state of a subscriber station having a worst channel state among the plurality of subscriber stations as an MCS level to be applied to the first information, and selecting MCS levels corresponding to the channel states of the plurality of subscriber stations as MCS levels to be applied to the second information;
an encoder for coding the first information and the second information using coding schemes corresponding to the MCS levels selected by the controller;
a modulator for modulating the first information and the second information coded by the encoder using modulation schemes corresponding to the MCS levels selected by the controller; and
a transmitter for converting a signal output from the modulator into a radio frequency (RF) signal and transmitting the RF signal.

10. The apparatus of claim 9, wherein the first information includes MCS levels applied to the second information, and location and size information of information corresponding to each of the MCS levels.

11. A method for receiving common control information transmitted from a base station to a plurality of subscriber stations located in a coverage area of the base station in a wireless communication, comprising the steps of:
demultiplexing a received signal to detect the common control information including first information that all of the plurality of subscriber stations commonly receive and second information that the plurality of subscriber stations separately receive according to channel states of the plurality of subscriber stations;
decoding the first information by demodulating and decoding the common control information according to a modulation scheme and a coding scheme corresponding to an MCS (Modulation and Coding Scheme) level applied to the first information in the base station; and
decoding the second information by demodulating and decoding the common control information according to a modulation scheme and a coding scheme corresponding to MCS levels applied to the second information in the base station.

12. The method of claim 11, wherein the first information includes the MCS levels applied to the second information, and location and size information of information corresponding to each of the MCS levels.

13. The method of claim 12, wherein the MCS level applied to the first information is an MCS level corresponding to a channel state of a subscriber station having a worst channel state among the subscriber stations.

14. The method of claim 11, wherein the MCS level applied to the first information have a modulation scheme with a lowest order and a coding scheme with a lowest coding rate among all MCS levels available in the base station.

15. The method of claim 14, wherein the MCS levels applied to the second information are adjusted by a predetermined level from MCS levels corresponding to the channel states of the plurality of subscriber stations.

16. The method of claim 14, wherein the MCS levels applied to the second information are MCS levels corresponding to the channel states of the plurality of subscriber stations.

17. The method of claim 13, wherein the MCS levels applied to the second information are adjusted by a predetermined level against the MCS levels corresponding to the channel states of the plurality of subscriber stations.

18. The method of claim 13, wherein the MCS levels applied to the second information correspond to the channel states of the plurality of subscriber stations.

19. The method of claim 15, wherein the MCS levels that are adjusted by the predetermined level from the MCS levels corresponding to the channel states of the plurality of subscriber stations have modulation schemes with a lower order than that of the modulation schemes of the MCS levels corresponding to the channel states of the plurality of subscriber stations, and have coding schemes with lower coding rates than that of coding schemes of the MCS levels corresponding to the channel states of the plurality of subscriber stations for the coding schemes for the level-adjusted MCS levels.

20. An apparatus for receiving common control information transmitted from a base station to a plurality of subscriber stations located in a coverage area of the base station in a wireless communication, comprising:
a receiver for demultiplexing a received signal to detect the common control information including first information that all of the plurality of subscriber stations commonly receive and second information that the plurality of subscriber stations separately receive according to channel states of the plurality of subscriber stations;
a demodulator for demodulating the common control information according to a modulation scheme corresponding to an MCS (Modulation and Coding Scheme) level applied to the first information in the base station, and demodulating the common control information according to modulation schemes corresponding to MCS levels applied to the second information; and
a decoder for decoding the demodulated common control information according to a coding scheme corresponding to an MCS level applied to the first information in the base station, and decoding the demodulated common control information according to the coding schemes corresponding to the MCS levels applied to the second information.

21. The apparatus of claim 20, wherein the first information includes the MCS levels applied to the second information, and location and size information of information corresponding to each of the MCS levels.

22. The apparatus of claim 21, wherein the MCS level applied to the first information has a modulation scheme with a lowest order and a coding scheme with a lowest coding rate among all the MCS levels available in the base station.

23. The apparatus of claim 22, wherein the MCS levels applied to the second information are MCS levels that are adjusted by a predetermined level against the MCS levels corresponding to the channel states of the plurality of subscriber stations.

24. The apparatus of claim 22, wherein the MCS levels applied to the second information are MCS levels corresponding to channel states of the subscriber stations.

25. The apparatus of claim 21, wherein the MCS level applied to the first information corresponds to a channel state of a subscriber station having a worst channel state among the plurality of subscriber stations.

26. The apparatus of claim 25, wherein the MCS levels applied to the second information are adjusted by a predetermined level from the MCS levels corresponding to the channel states of the plurality of subscriber stations.

27. The apparatus of claim 25, wherein the MCS levels applied to the second information correspond to the channel states of the plurality of subscriber stations.

28. The apparatus of claim 22, wherein the MCS levels that are adjusted by the predetermined level from the MCS levels corresponding to the channel states of the plurality of subscriber stations have modulation schemes with a lower order than that of the modulation schemes of the MCS levels corresponding to the channel states of the plurality of subscriber stations, and have coding schemes with lower coding rates than that of coding schemes of the MCS levels corresponding to the channel states of the plurality of subscriber stations for the coding schemes for the level-adjusted MCS levels.

29. A method for transmitting common control information from a base station to a plurality of subscriber stations located in a coverage area of the base station in a wireless communication, comprising the steps of:
classifying the plurality of subscriber stations into a plurality of groups according to channel states thereof; and
transmitting common control information corresponding to the plurality of groups using MCS (Modulation and Coding Scheme) levels corresponding to the channel states of the groups.

30. The method of claim 29, further comprising the step of transmitting the common control information corresponding to the plurality of groups using MCS levels that are adjusted by a predetermined level from the MCS levels corresponding to the channel states of the plurality of groups.

31. The method of claim 30, wherein the MCS levels that are adjusted by the predetermined level from the MCS levels corresponding to the channel states of the plurality of subscriber stations have modulation schemes with a lower order than that of the modulation schemes of the MCS levels corresponding to the channel states of the plurality of subscriber stations, and have coding schemes with lower coding rates than that of coding schemes of the MCS levels corresponding to the channel states of the plurality of subscriber stations for the coding schemes for the level-adjusted MCS levels.

32. An apparatus for transmitting common control information from a base station to a plurality of subscriber stations located in a coverage area of the base station in a wireless communication system, comprising:
a controller for classifying the plurality of subscriber stations into a plurality of groups according to channel states thereof, and selecting MCS (Modulation and Coding Scheme) levels corresponding to the channel states of the plurality of groups as MCS levels to be applied to the common control information corresponding to each of the plurality of groups;
an encoder for coding the common control information using coding schemes corresponding to the MCS levels selected by the controller;
a modulator for modulating the common control information coded by the encoder using the modulation schemes corresponding to the MCS levels selected by the controller; and
a transmitter for converting a signal output from the modulator into a radio frequency (RF) signal, and transmitting the RF signal.

33. The apparatus of claim 32, wherein the controller determines MCS levels that are adjusted by a predetermined level from the MCS levels corresponding to the channel states of the plurality of groups to be applied to the common control information corresponding to each of the plurality of groups.

34. The apparatus of claim 33, wherein the MCS levels that are adjusted by the predetermined level from the MCS levels corresponding to the channel states of the plurality of subscriber stations have modulation schemes with a lower order than that of the modulation schemes of the MCS levels corresponding to the channel states of the plurality of subscriber stations, and have coding schemes with lower coding rates than that of coding schemes of the MCS levels corresponding to the channel states of the plurality of subscriber stations for the coding schemes for the level-adjusted MCS levels.

35. A method for receiving common control information transmitted from a base station to a plurality of subscriber stations located in a coverage area of the base station in a wireless communication system, comprising the steps of:
demultiplexing a received signal, and detecting common control information that the plurality of subscriber stations receive separately, according to channel states thereof; and
demodulating and decoding the common control information according to modulation schemes and coding schemes corresponding to MCS (Modulation and Coding Scheme) levels applied to the common control information in the base station.

36. An apparatus for receiving common control information transmitted from a base station to a plurality of subscriber stations located in a coverage area of the base station in a wireless communication system, comprising:
a receiver for demultiplexing a received signal, and detecting common control information that the plurality of subscriber stations receive separately, according to channel states thereof;
a demodulator for demodulating the common control information according to modulation schemes corresponding to MCS (Modulation and Coding Scheme) levels applied to the common control information in the base station; and
a decoder for decoding the demodulated common control information according to coding schemes corresponding to the MCS levels.

37. A method for transmitting common control information from a base station to a plurality of subscriber stations located in a coverage area of the base station in a wireless communication, comprising the steps of:
classifying the plurality of subscriber stations into a plurality of groups according to channel states thereof;
generating a first common control information that is commonly transmitted in common to the plurality of subscriber stations, wherein the first common control information is placed with a lower rate coding and modulation before other information; and
generating a second common control information that is separately transmitted to at least one of the plurality of groups, wherein each of the second common control information has a different modulation and coding rate.

38. The method of claim 37, wherein the second common control information includes a description of a location, a coding scheme, and a modulation scheme for at least one of the plurality of groups.
